(19) United States
(12) Patent Application Publication
(10) Pub. No.: US 2009/0239188 A1
(43) Pub. Date: Sep. 24, 2009

(54) TRANSDUCTION ORTHODONTIC DEVICES

(75) Inventors: Kang Ting, Beverly Hills, CA (US); Chia Soo, Beverly Hills, CA (US)

Correspondence Address: SQUIRE, SANDERS & DEMPSEY L.L.P., 1 MARITIME PLAZA, SUITE 300, SAN FRANCISCO, CA, 94111, US

(73) Assignee: REIKA ORTHO TECHNOLOGIES, INC. Changzhou Hi-Tech District Multiple Dime, Jiangsu (CN)

(21) Appl. No.: 12/303,074

(22) PCT Filed: Jun. 6, 2007
(86) PCT No.: PCT/US07/13622

§ 371 Date: May 21, 2009

Related U.S. Application Data
(60) Provisional application No. 60/811,653, filed on Jun. 6, 2006.

(51) Int. Cl. A61C 7/00

(52) U.S. Cl. 433/2; 433/24

(57) ABSTRACT

Provided herein is a transduction cyclic force system for moving and/or repositioning teeth.

### FIELD OF INVENTION

The present invention generally relates to orthodontic devices for moving tooth towards a predefined pattern and/or position.

### BACKGROUND OF THE INVENTION

Orthodontics involves the use of mechanical forces to move teeth within the jaw bone and therefore, relies on force-induced bone remodeling. A force is a physical quantity and has several essential properties such as the magnitude, direction, point of application and frequency. All these properties of orthodontic forces have been subjects of scientific research and considered in clinical practice of orthodontics with the exception of force frequency. Exclusive use of continuously applied static forces in orthodontics and the resulting lack of consideration of force frequency contradict the overall scientific consensus-based evidence obtained from orthopedic studies of long bones that cyclic forces induce more effective bone remodeling than static forces of matching magnitude.

The current orthodontic technology uses continuously applied static forces to move the teeth towards predetermined positions to achieve esthetically pleasing look is its predictable, albeit slow, outcome, inducing controlled tooth movement towards predetermined position when treatment is carried out by a competent orthodontist. However, the current orthodontic technology takes a relatively long period of time, which causes inconveniences to the patient and can be a financial burden.

Although rapid cyclic forces; i.e., forces with rapidly varying magnitude over time have been proposed to induce more rapid tooth movement (U.S. Pat. Nos. 6,832,912 and 6,648,639) than the presently used continuous forces, these devices are impractical to use. Therefore, there is a need for new orthodontic technologies.

The following embodiments address the above identified problems and needs.

### SUMMARY OF THE INVENTION

Provided herein is an orthodontic device for moving tooth/teeth toward a predetermined position. The device comprise a first appliance which is a transduction cyclic force system for priming and causing the too/teeth to assume a primed state and at least one second appliance for moving tooth/teeth to a predetermined position. The first appliance includes a transducer material which, upon exposure to a stimulus such as electricity or a magnetic field, generates a cyclic force, thereby providing a stimulation that facilitates tooth movement. The cyclic stimulation can prime the tooth so as to cause the tooth to assume the primed state.

The transducer material can be any material capable of generate a cyclic force upon exposure to a stimulus (e.g., electricity or a magnetic field). Such transducer material can be, for example, a piezoelectric material which can be crystals, ceramics, polymers, or combinations thereof. In some embodiments, the material capable of generating a cyclic force can be a composite that includes any of the transducer materials.

The cyclic force system provided herein can be used in orthodontics for moving tooth/teeth, optionally to a predetermined position.

### DETAILED DESCRIPTION OF THE INVENTION

Provided herein is an orthodontic device for moving tooth/teeth toward a predetermined position. The device comprise a first appliance which is a transduction cyclic force system for priming and causing the too/teeth to assume a primed state and at least one second appliance for moving tooth/teeth to a predetermined position.

The first appliance includes a transducer material which, upon exposure to a stimulus such as electricity or a magnetic field, generates a cyclic force, thereby providing a stimulation that facilitates tooth movement. The cyclic stimulation can prime the tooth so as to cause the tooth to assume a primed state. The transducer material can be any material capable of generate a cyclic force upon exposure to a stimulus (e.g., electricity or a magnetic field). Such transducer material can be, for example, a piezoelectric material which can be crystals, ceramics, polymers, or combinations thereof. In some embodiments, the material capable of generating a cyclic force can be a composite that includes any of the transducer materials. The cyclic force system provided herein can be used in orthodontics for moving tooth/teeth, optionally to a predetermined position.

The second or subsequent appliances provide realigning force to the tooth/teeth. The appliance(s) allow the tooth/teeth to move from the primed state to a predetermined position.

The term “system” can be used interchangeably with the term “device.”

### I. Transduction Cyclic Mechanical Force for Priming Teeth

Stress-Strain Related Bone Regeneration

As described in Meyer, U. et al. Biomechanical and clinical implications of distraction osteogenesis in craniofacial surgery. J Craniomaxillofac Surg 32, 140-9 (2004), bone has an adaptive behavior toward a changing mechanical environment, which is regarded as phenotype plasticity. Specific strain-dependent signals are thought to control this adaptive mode of bony tissue modeling. The adaptive mechanisms include basic multicellular units (BMUs) of bone remodeling. Effector cells within BMUs have been shown to function in an interdependent manner. While hormones can bring about as much as 10% of the postnatal changes in bone strength and mass, 40% are determined by mechanical effects. This has been shown by the loss of extremity bone mass in patients with paraplegia (more than 40%). Modeling occurs by separate formation and resorption drifts to reshape, thicken, and strengthen a bone or trabecula by moving its surfaces around in tissue space. Remodeling also involves both resorption and formation of bone. BMUs turn bone over in small packets through a process in which an activating event causes some bone resorption and bone formation is following

Mechanotransduction of Osteoblasts

It is generally suggested that forces leading to cellular deformation are signaled to the cellular genome through mechanotransduction (Meyer, U. et al. J Craniomaxillofac Surg 32, 140-9 (2004)). Mechanotransduction, or the conversion of a biophysical force into a cellular response, is an essential mechanism in bone biology. It allows bone cells to respond to a changing mechanical environment. Mechanotransduction can be categorized in an idealized manner into (1) mechanocoupling, which means the transduction of mechanical force applied to the tissue into a local mechanical signal perceived by a bone cell; (2) biochemical coupling, the transduction of a local mechanical signal into biochemical signal cascades altering gene expression or protein activation; (3) transmission of signals from the sensor cells to effector cells, which actually form or remove bone; and ultimately (4) the effector cell response.

When loads are applied to bone, the tissue begins to deform causing local strains (typically reported in units of microstrain; 10,000 microstrain=1% change in length). It is well known that osteoblasts and osteocytes act as the sensors of local bone strains and that they are appropriately located in the bone for this function.

In Vitro Mechanical Stimulation

The ability of living tissues to remodel in response to cyclic loads suggests that similar adaptive processes can occur in engineered tissues in vitro. Since the early work of Glucksmann in 1939 (Glucksmann A. Anatomical Record 73:39-56 (1939)), a vast array of stimulation devices have been constructed to load cells in compression, tension, bending, out-of-plane distension, in-plane distention, shear, and combinations of the above (recently reviewed by Brown). A number of studies have shown that mechanically challenged tissue constructs show hypertrophy and increased orientation of fibers and cells in comparison to control constructs. Fink et al subjected cells in a collagen gel to cyclic stretch at 1.5 Hz and observed significant changes in cell arrangement into parallel arrays, increases in cell length and width, and increases in myochondrial density. Functionally, the tissue had a contractile force 2-4 times that of the control (Fink, C; et al., Faseb Journal 14(5):669-79 (2000)). Buschmann et al found increased extracellular matrix biosynthesis in collagenous tissues by subjecting chondrocytes in an agarose gel to 3% strain at 0.01-1.0 Hz (Buschmann, M D; et al., Journal of Cell Science, 108 (Pt 4):1497-508 (1995)). Zeichen et al found increased cell proliferation by cyclically stretching the cells 5% strain (50,000 microstrains) at 1 Hz for 15-60 minutes (Zeichen, J; et al., American Journal of Sports Medicine 2000 November-December, 28(6):888-92). Similarly, Desrosiers et al reported significant increase in cell proliferation, collagen synthesis, and proteoglycan synthesis by 10% strain (100,000 microstrains) at 0.1 Hz for 24 hours on an elastomeric substrate and (Desrosiers, E. A., et al., Ann. Chir 49, 768-774 (1995)).

High Frequency Effects

It has long been known that low strain, high frequency stimulation (e.g. 50με @ 30 Hz) can induce similar (Qin, Y. X., et al., J. Orthop. Res. 16, 482-489 (1998)), if not more (Hsieh Y. F. and Turner C. H., Journal of Bone and Mineral Research 16:918-924 (2001)), stimulatory effects than high strain low frequency (e.g. 1,000με @ 1 Hz). Recently, Rubin et al. uncovered evidence that brief applications (e.g. 10 minutes) of barely perceptible vibrations at high frequencies (e.g. 0.25 g @ 90 Hz) stimulated bone growth better than weight-bearing activity for the same duration (Rubin C, et al., FASEB J. 15(12):2225-9). Osteoblast response to low frequency, high loads has been shown (Tanaka, S. M., et al., Journal of Biomechanics, 36(1):73-80 (2003)) to be sensitized by high frequency (50 Hz), low amplitude signals through a phenomenon termed stochastic resonance which has been reported by Collins et al. (Collins J. J., Imhoff T. T. and Grigg P. Noise-enhanced tactile sensation. Nature 1996, 383:770) to enhance the sensitivity of mechanoreceptors.

Static Force

Continuously applied static forces have been studied and/or used in previous studies and clinical practice in orthodontics. Continuously applied static forces are used on a daily basis for orthodontic tooth movement in these patients. Day-to-day practice of application of continuously applied static forces in clinical orthodontics, orthodontic tooth movement has been simulated in animal models with elastics and coil springs [Reitan (1951) Acta Odont. Scand. Suppl., 6:1-240; Storey et al., (1952) Aust. J. Dent., 56:11-18; Pygh et al., (1982) In Berkivitz et al. (Eds) The Periodontal Ligament in Health and Disease, Pergamon Press, Oxford, England, pp. 269-290; Jager et al., (1993) Histochemistry, 100:161-166; Ashizawa et al., (1998) Arch Oral Biol., 43(6):473-484; Gu et al., (1999 Angle Orthod. 69(6):515-522; Melsen (1999) Angle Orthod., 69(2):151-158; Terai et al., (1999) J. Bone Miner. Res., 14(6): 839-849; Tsay et al., (1999) Am. J. Orthod. Dentofacial Orthop., 115(3):323-330; and Verna (1999) Bone, 24(4):371-379].

Threshold force and the duration of force application are two fundamental concepts in the art of orthodontics. A minimum of 6 hours was proposed to be the threshold below which orthodontic tooth movement does not occur [Proffit et al., (1993) Mosby Year Book: St. Louis. pp. 266-288]. However, this projected minimum threshold of 6 hours per day by Proffit et al. is largely theoretical, as stated in the caption of FIGS. 9-12 on page 275 of that work. Empirical clinical experience appears to support the notion that orthodontic forces must be applied beyond certain daily duration in order to induce tooth movement, the precise minimum daily duration is unclear. What appears of more significance than daily minimum duration is the overall duration of orthodontic treatment in association with current technology.

The precise threshold force magnitude required for tooth movement has not yet to be determined. In general a few hundred grams of force have been implicated to be the threshold for tooth movement. However, there remain projections as “theoretically, there is no doubt that light continuous forces produce the most efficient tooth movement” [Proffit et al., (1993) Mosby Year Book: St. Louis. pp. 266-288]. It has been shown that proliferation of periodontal ligament cells is greater in response to continuous forces than to intermittent forces of the same magnitude [Reitan (1951) Acta Odont. Scand. Suppl., 6:1-240]. These intermittent forces were static forces applied intermittently over time [Reitan (1951) Acta Odont. Scand. Suppl., 6:1-240; van Leeuwen et al., (1999) Eur. J. Oral Sci., 107(6):468-474].

Non-Static Forces

Intermittent forces were used in orthodontic treatment of malocclusion. The nature of the intermittent forces was static forces applied intermittently over time, for instance, two hours on and two hours off [Reitan (1951) Acta Odont. Scand. Suppl., 6:1-240; van Leeuwen et al., (1999) Eur. J. Oral Sci., 107(6):468-474]. Cyclic force systems were also described in U.S. Pat. Nos. 6,648,639 and 6,832,912 to Mao et al. However, the cyclic force systems are impractical to use. A cyclic force system using cyclic forces generated by a motor for treating tooth malocclusion is described U.S. Pat. Nos. 6,832,912 and 6,648,639, the teachings of which are incorporated herein by reference.

Transduction Cyclic Force

In accordance with one aspect of the present invention, cyclic forces are generated through transducer shells and used to expedite the remodeling of tooth or teeth. Thus, this invention concerns the remodeling of a mammal's face by realigning one or more of the mammal's teeth. Exemplary mammals are humans, apes, monkeys, rabbits, mice, rats and other laboratory animals as well as companion animals such as cats and dogs, and livestock such as pigs, goats, horses, cattle, sheep and the like.

As used herein, the term “transducer shell” refers to an orthodontic force system that includes at least one transducer material (e.g., piezoelectric crystals or an amount of a piezoelectric compound or material). The force system can take any form suitable for use in orthodontics. In some embodiments, the force system includes the geometry of a tooth that requires of an orthodontic treatment. Such force systems can be fixed or movable.

The term “tooth” and “teeth” are used interchangeably.

Some examples of the force systems can take the form of, for example, shells, rings, or toothlock. Some further examples of the force system can be generally referred to as geometries.

In some embodiments, the force system can be multiple teeth (entire arch or partial arch) stimulation, which include, but are not limited to, mouthguard like device, palatal expander like device, retainer like device, bleaching tray like device, or bleaching-strip-like device that adhere to teeth.

In some further embodiments, the force system can be single tooth stimulation, which include, but are not limited to, tooth-colored, tooth-form shells; and transparent or translucent, tooth-form shells.

In some embodiments, the force system can be non-tooth-form shells that are bonded to the tooth and can also be used, if desired, as leveraging structures for orthodontic movement. This allows conventional wires or elastics or computer devices and aligners to be adapted to include the transduction force system described herein.

Transducer Materials

The transducer material or compound that can be used to provide for the cyclic force system includes any transducer material, either known or will become known in the future. Some exemplary transducer materials or compounds include, but are not limited to, materials in the general categories of piezoelectric crystals, ceramics, polymers, magneostrictive alloys, and electrostrictive ceramics. Examples of common piezoelectric crystals include quartz, barium titanate, lithium niobate, rochelle salt, ammonium dihydrogen phosphate, potassium dihydrogen phosphate, tourmaline, zinc blende, lithium tantalate, and bismuth germanium oxide. Common piezoelectric ceramics include barium titanate, lead titanate, lead zirconate, lead metanicbate, and lead zirconate titanate. Piezoelectric polymers are exemplified by polyvinylidene fluoride and their copolymers with trifluoroethylene and tetraflouoroethylene, polyamides, polyureas, and liquid crystal polymers, and amporphous polymers such as polyacrylonitrile, poly(vinylidenecyanide vinylacetate, polyvinyl chloride, polyvinyl acetate, polyphenylethernitrile, poly(9,9-di-n-octylfluorenyl-2,7-vinylene) (PFV), poly(benzyl glutamate), poly(methyl glutamate), cellulose triacetate, polypropylene oxide), poly(1-bicyclobutanecarbonitrile) and combinations thereof. Electrostrictive ceramics such as lead magnesium niobate-lead titanate and magnetostrictive materials such as terbium dysprosium iron (Terfenol-D), and terbium dysprosium can also be used for the said applications.

Some examples of piezoelectric crystals, ceramic materials or compositions include, but are not limited to, LiNbO₃, LiTaO₃, BaTiO₃, PbTiO₃, PbZrO₃, Pb₂Nb₂O₆, and combinations thereof. In some embodiments, the ceramics can be a compound of two or more ceramics, some embodiments of these ceramic compounds include, but are not limited to, Pb(Mg_{1/3}Nb_{2/3})TiO₃—PbTiO₃—PbZrO₃, Na_{0.5}K_{0.5}NbO₃, Pb_{0.6}Ba_{0.4}Nb₂O₆, Pb(Zr_{0.55}Ti_{0.45})O₃, Pb_{0.99}Ca_{0.01}(Zr_{0.53}Ti_{0.47})O₃, Pb_{0.95}Ca_{0.05}(Zr_{0.53}Ti_{0.47})O₃, Pb_{0.92}Ca_{0.08}(Zr_{0.53}Ti_{0.47})O₃, Pb_{0.99}Sr_{0.01}(Zr_{0.53}Ti_{0.47})O₃, Pb_{0.95}Sr_{0.05}(Zr_{0.53}Ti_{0.47})O₃, Pb_{0.90}Sr_{0.10}(Zr_{0.53}Ti_{0.47})O₃, Pb_{0.85}Sr_{0.15}(Zr_{0.53}Ti_{0.47})O₃, Pb_{0.80}Sr_{0.20}(Zr_{0.53}Ti_{0.47})O₃, Pb_{0.875}Sr_{0.125}(Zr_{0.56}Ti_{0.44})O₃, and combinations thereof.

In some embodiments, the transducer material can be a transducer composite material. The composite can be a transducer material and a non-transducer material. The non-transducer material can be any biocompatible material, which can be polymer or a non-polymer. In some embodiments, the polymer can be polyolefin such as rubber, polyester, epoxy polymer, rubber, etc., and the non-polymer can be, e.g., glass, carbon fiber, glass fiber, glass spheres, silica, alumina, ceramics, etc. Some exemplary composite materials include, but are not limited to Pb(Zr,Ti)O₃ (PZT), PZT-epoxy, PZT-rubber, PZT-epoxy with glass spheres, PbTiO₃-rubber, and combinations thereof.

In some embodiments, the transducer material can exclude any of the above crystals, ceramics, polymers, and/or composites.

Force Frequency

The frequency of cyclic force of the device described herein can be determined by the transducer material used. Each transducer material or compound has a frequency, which is well documented in the art. Some exemplary frequencies of piezoelectric compounds are can be found at Yuhuan Xu, Perroelectric Materials and Their Applications, North Holland, 1991, Amsterdam, London, New York, Tokyo.

The magnitude of cyclic force of the device described herein can be determined by the amount of the transducer compound or material used in the device. The cyclic force can be aligned to any of the x, y, or z direction or any of the planes that can be defined by a set of coordinates (x,y,z). For example, to align the cyclic force to a given direction or plane, the opposite direction or plane of the device can be fixed or locked to a tooth or teeth such that the cyclic force can act on the given direction or plane. One of ordinary skill in the art would determine, according to a given prescription, to choose an amount of one or more transducer compound/material for forming the device defined herein or to select a formed device containing an amount of one or more transducer compound(s)/material(s).

In some embodiments, the systems provided herein is capable of providing a cyclic force having a frequency above about 0.001 Hz, above about 0.01 Hz, above about 0.1 Hz, above about 1 Hz, above about 2 Hz, above about 10 Hz, above about 20 Hz, above about 40 Hz (for example, 40.1 Hz or above), or above about 100 Hz. Some exemplary ranges of frequency are from about 0.001 Hz to about 100,000 Hz, from about 0.01 Hz to about 100,000 Hz, from about 1 Hz to about 100,000 Hz, from about 5 Hz to about 100,000 Hz, from about 20 Hz to about 100,000 Hz, from about 40 Hz (e.g., 40.1 Hz) to about 100,000 Hz, from about 100 Hz to about 100,000 Hz, from about 0.01 Hz to about 100 Hz, from about 1 Hz to about 100 Hz, from about 2 Hz (e.g., 2.1 Hz) to about 100 Hz, from about 5 Hz to about 100 Hz, from about 20 Hz to about 100 Hz, from about 10 Hz to about 100 Hz, from about 40 Hz (e.g., 40.1 Hz) to about 100 Hz, from about 1 Hz to about 40 Hz, from about 10 Hz to about 40 Hz, from about 20 Hz to about 40 Hz.

In some embodiments, the systems provided herein can specifically exclude any of the above mentioned frequencies or frequency ranges.

In some embodiments, the system described herein is capable of providing a cyclic force having a magnitude in the range between about 0.001 Newton to about 20 Newton, e.g., about 0.001 Newton, about 0.005 Newton, about 0.01 Newton, about 0.02 Newton, about 0.03 Newton, about 0.04 Newton, about 0.05 Newton, about 0.06 Newton, about 0.07 Newton, about 0.08 Newton, about 0.09 Newton, about 0.1 Newton, about 0.2 Newton, about 0.3 Newton, about 0.4 Newton, about 5 Newton, about 0.6 Newton, about 0.7 Newton, about 0.8 Newton, about 0.9 Newton, about 1 Newton, about 2 Newton, about 3 Newton, about 4 Newton, about 5 Newton, about 6 Newton, about 7 Newton, about 8 Newton, about 9 Newton, about 10 Newton, or about 15 Newton.

In some embodiments, the cyclic force system described herein is capable of generating a load of ranging from about 0.1 microstrain to about 1,000,000 microstrains. For example, the cyclic force system is capable of generating a load of about 0.2, about 0.5, about 1, about 5, about 10, about 50, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, about 10,000, about 15,000, about 20,000, about 25,000, about 30,000, about 35,000, about 40,000, about 45,000, about 50,000, about 55,000, about 60,000, about 65,000, about 70,000, about 75,000, about 80,000, about 85,000, about 90,000, about 95,000, about 100,000, about 250,000, about 300,000, about 350,000, about 400,000, about 450,000, about 500,000, about 550,000, about 600,000, about 650,000, about 700,000, about 750,000, about 800,000, about 850,000, about 900,000, or about 950,000 micrstrains.

In some embodiments, the systems provided herein can specifically exclude any of the above mentioned loads or force magnitudes.

In some embodiments, where the system is used for orthodontic tooth/teeth movement, the systems provided herein can specifically exclude any of the frequencies, magnitudes, and/or loads described above. For example, in these embodiments, where the cyclic force is aligned in a direction of desired alignment, the system can specifically exclude one or both of the following: the frequency of the cyclic force in the range between 0.1 Hz and 2 Hz or between 0.1 Hz and 40 Hz, or the magnitude up to 10 Newton or in the range between 0.1 and 5 Newton.

Priming Appliance

Tooth can be subjected to transduction cyclic force priming. As described below, the priming appliance is capable of generating transduction mechanic force in different direction. Assuming the position of a tooth can be defined by x,y,z coordinates, the cyclic force can exert forces in any of the x,y,z directions. Assume the direction of tooth realignment to be the z direction. Because the priming appliance does not provide realigning force, the tooth will not move toward the predetermined position. There will be no net movement in the z direction for the tooth.

Therefore, the primed state of the tooth is a state where the osteoblast activities in the tissue surrounding the tooth is activated and/or enhanced and the geometry of the tooth has a loosened rooting, causing the tooth to be ready to move and realign. Further, upon realignment to a new position, the tooth in a primed state can be fixed to the new position at a higher rate due to the enhanced osteoblast activity of the tissue surrounding the tooth.

### II. Teeth Realignment

Tooth Realignment

The system or device provided in the present invention includes one or more appliances for moving teeth/tooth from the primed state to a predetermined position (e.g., the final position of the orthodontic treatment).

In some embodiments, the system allows a prescribing orthodontic doctor to evaluate a tooth arrangement during the course of treatment and to determine an optimal force application through selection of orthodontic appliances. Optimal force application as used herein is defined as an optimal balance between efficient tooth/teeth movement and patient comfort. From a practical standpoint, optimal force application can be achieved through integrating known teeth positions optimal appliance geometries and forces.

In some embodiments, the system can include at least two cycles of appliances having geometries selected to successively move or reposition teeth from the primed state to the final position. The second appliance can be formed using a digital data set obtained based on the primed state of the tooth, which can be predicted from the primed state of a tooth, and the second cycle of appliances can be formed using a data set obtained based on the last tooth arrangement achieved by the first appliance cycle or the cycle prior to the last cycle. The second cycle data set can be important because it can identify and reduce or minimize discrepancies between actual and predicted positions for tooth/teeth movement. The first cycle data set can be obtained by dental impressions, oral scanners, or other modalities known to those in the art. The second cycle data set (and all other cycles beyond the first set) can be obtained by, e.g., clinical exam, dental impressions, oral scanners, or other modalities known to those in the art. The second cycle data set (and all other cycles beyond the first set) can be digital or non-digital depending on the discretion of the prescribing orthodontic doctor.

In another aspect, the system described herein can include a system of de-escalting and/or escalating forces with each appliance cycle. Each appliance cycle includes at least two appliances of varying geometries and/or forces from which the prescribing orthodontic doctor can decide if de-escalting, escalating and/or combinations of de-escalting/escalating forces are most appropriate.

In some embodiments, the system described herein includes a cyclic force system for repositioning teeth from an initial tooth arrangement to a final tooth arrangement. The system includes a cycle of a plurality of appliances that includes: (a) a first appliance for priming teeth to cause the teeth to assume the primed state; (b) a second appliance having a geometry selected to reposition the teeth from the primed state to a first intermediate arrangement; (c) optionally one or more intermediate appliances having geometries selected to progressively reposition the teeth from the first intermediate arrangement to successive intermediate arrangements; and (d) a final appliance having a geometry selected to progressively reposition the teeth from the last intermediate arrangement to the final tooth arrangement.

The appliances in the system described herein can have different forces that can be designed and tailored by varying parameters such as, but not limited to dimensions (e.g., thickness and/or geometry) and/or material characteristics.

The appliances in the system described herein can include successive locks having different geometries shaped to receive and allow the appliances to reposition teeth from one arrangement to a successive arrangement. The locks can be any mechanism capable of receiving the teeth so as to allow the appliances to incrementally move or adjust teeth from one arrangement to another. The locks can be, for example, metallic, plastic or polymeric wires, clips, rings, caves, or shells. In some embodiments, the locks specifically exclude polymeric shells.

The system described herein can provide specifications of the appliances such that an orthodontic doctor can prescribe the order of use of the appliances based on the specifications. Specifications can include, but are not limited to dimensions (e.g., force, thickness, and/or geometry) and/or material characteristics. In some embodiments, the cycles in the system can be marked to indicate the sequence of cycles. In some other embodiments, the appliances can be marked such that an orthodontic doctor can prescribe the order of using the appliances.

Tooth Repositioning

Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and systems will reposition teeth in from ten to twenty-five successive steps, although complex cases involving many of the user's teeth can take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances will usually not be the same for any particular tooth.

The system includes cycles of successive appliances with different geometries that define teeth positions corresponding to different stages of treatment. The system can include only one cycle of successive appliances. The system can include a multiple cycles of successive appliances; each cycle other than the final cycle is capable of moving the teeth to an intermediate position; and the final cycle is capable of moving the teeth to the final position from the last intermediate position. For example, for a two cycle system, the first cycle can move the teeth from the primed state (position 1) to an intermediate position (position 2), and the second cycle can then move the teeth from position 2 to the final position. For a three cycle system, the first cycle can move the teeth from the primed state (position 1) to the first intermediate position (position 2), the second cycle can then move the teeth from position 2 the second intermediate position (position 3), and the final cycle can move the teeth from position 3 to the final position.

In one aspect of the present invention, the tooth repositioning system described herein comprises at least two appliances, e.g., about 2 to about 20 appliances, about 2 to about 15 appliances, about 2 to about 10 appliances, about 2 to about 8 appliances, about 2 to about 5 appliances, about 3 to about 20 appliances, about 3 to about 15 appliances, about 3 to about 10 appliances, about 3 to about 8 appliances, about 3 to about 5 appliances, about 4 to about 20 appliances, about 4 to about 15 appliances, about 4 to about 10 appliances, about 4 to about 8 appliances, about 4 to about 5 appliances, about 5 to about 20 appliances, about 5 to about 15 appliances, about 5 to about 10 appliances, about 5 to about 8 appliances, or about 5 appliances.

The appliances have one or more geometries defining the positions of the teeth at the onset of the orthodontic treatment (primed states), in the middle of the orthodontic treatment (intermediate positions), or at the completion point of the orthodontic treatment (final positions). Each of the appliances is different in terms of dimensions (e.g., force, thickness, and/or geometry) and/or material characteristics, which correspond to the torch modulus and forces that progressively move teeth from one position to another.

Systems described herein include at least a first appliance for priming a tooth to cause the tooth to assume the primed state where individual teeth will be incrementally repositioned. The system further comprises at least one intermediate appliance having a geometry selective to progressively reposition teeth from the primed state to one or more successive intermediate arrangements. The system still further comprises a final appliance having a geometry selected to progressively reposition teeth from the last intermediate arrangement to the desired final tooth arrangement. In some cases, it is desirable to form the final appliance or several appliances to “over correct” the final tooth position, as discussed in more detail below.

As described in more detail below in connection with the methods of the present invention, the systems is planned and all individual appliances for the first cycle fabricated at the outset of treatment, and the appliances is thus be provided to the orthodontic doctor as a single package or system. The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e,g., near zero), while the last appliance of the first cycle is expected to have a larger discrepancy (e.g., larger than zero). The exact units for the discrepancy is expressed as, but not limited to, a percentage, a metric measurement, or other numerical system (e.g., scale of 0 to 25; with 25 being maximum discrepancy). The calculation of the discrepancy can be based to varying degrees on degree of teeth movement required, the appliance dimensions, the appliance material characteristics, and the use or non-usage of anchoring devices (e.g., dental implants in bone). Upon obtaining the proper sequence of appliance usage, the user can place the appliances over his or her teeth at a frequency prescribed by the orthodontist or other treating professional. Unlike braces, the user need not visit the treating professional every time an adjustment in the treatment is made. While the users will usually want to visit their treating professionals periodically to assure that treatment is going according to the original plan, eliminating the need to visit the treating professional each time an adjustment is to be made allows the treatment to be carried out in many more, but smaller, successive steps while still reducing the time spent by the treating professional with the individual user. Moreover, the ability to use polymeric shell appliances which are more comfortable, less visible, and removable by the user, greatly improves user compliance, comfort, and satisfaction.

The individual appliances will preferably comprise a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the user, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step. However, this accommodation or conforming to the misaligned teeth through successive appliance geometries results in increasing discrepancies between actual teeth positions and expected (predicted) teeth positions.

The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e,g., near zero), while the last appliance of the first cycle is expected to have a larger discrepancy (e.g., larger than zero). The exact units for the discrepancy is expressed as, but not limited to, a percentage, a metric measurement, or other numerical system. The calculation of the discrepancy can be based variably on the degree of teeth movement required, the appliance dimensions, the appliance material characteristics, and the use or non-usage of anchoring devices (e.g., dental implants in bone).

The individual appliances described herein also exert different forces on a tooth arrangement. The different force pertaining to each appliance is achieved by increasing thickness and rigidity while keeping the same elastic modulus or changing the material properties such as elastic modulus and stiffness while not changing the thickness or changing any combination of thickness, rigidity, elastic modulus, and/or material properties. Note, the force exerted on a given tooth or series of teeth is distinct, although somewhat dependent on the material and/or mechanical properties of the appliance. The force pertaining to the appliance is generally related to the thickness, rigidity, elastic modulus, and/or material properties of the appliance. In contract, the force exerted on a given tooth or series of teeth is generally related to the actual teeth positions and desired teeth positions, geometry of the appliance in achieving the desired teeth positions, as well as the material and/or mechanical properties of the appliance and whether any anchoring dental implant devices are employed.

In one embodiment, the system described herein includes one or more than one cycle of appliances with differential de-escalting and/or escalating force system (e.g., from high-to-low, low-to-high, high-to-high, low-to-low, high-to-low-to-high, low-to-high-to-low, etc). The combinations of de-escalting and/or escalating force systems are only limited by appliance number per cycle. For example, the system can include a first appliance for priming teeth to cause the teeth to assume the primed state, one or more intermediate appliances with high force having geometries and reducing force system selected to progressively reposition the teeth from the primed state to successive intermediate arrangements, and a final appliance with lowest force system in a cycle having a geometry selected to progressively reposition the teeth from the last intermediate arrangement to an end tooth arrangement. If necessary, a new cycle of force system will start from the end tooth arrangement of the previous cycle until the whole treatment finished.

For each cycle, a description of the force systems will be provided to describe the force of each appliance and to suggest to the treating orthodontic doctor the order of using each individual appliance in predetermined differential force which will progressively move the user's teeth toward the final arrangement, a package, said package containing one cycle of appliances, wherein the appliances are provided in a single package to the user. The treating orthodontics will then provide to the user the proper order of using the appliances on the basis of each user's condition and the doctor's professional judgment and discretion.

In some embodiment, the system described herein comprises one or more than one cycle of appliances. Each cycle contains one or more appliances having a differential de-escalting and/or escalating force system as previously described. In some embodiments, each cycle of the system can be marked for the sequence of the cycles.

The different force pertaining to each appliance is made different by changing the dimension and/or material characteristics of the appliances. For example, the appliances can be made to have different thickness to generate different forces. For example, the appliances can have a thickness ranging from about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm or about 2.0 mm. In some other embodiments, different forces of appliances can be achieved using different material forming the appliances. For example, the material can be blended with reinforcement materials such as fibers, pieces, strips, wires, mesh, lattices, networks, interpenetrating networks, or combinations thereof to cause the appliances to have different forces.

To achieve desired speed of orthodontic treatment, the forces of individual appliances in a cycle can be tailored to meet the needs of treatment. For example, in each cycle, the subsequent appliance can be made to differ from the prior appliance stiffness, in the range from, e.g., about 0.1 to about 8 Gpa. In some embodiments, in each cycle of appliance, the prior appliance can be made to have an elastic modulus that differs from the elastic modulus of the subsequent appliance by about 1% to about 800%. In some other embodiments, in each cycle, the subsequent appliance thickness can be made to differ from the prior appliance thickness, in the range from about 0.1 to about 2 mm.

In an embodiment, the system described herein for repositioning teeth from an initial tooth arrangement to a final tooth arrangement comprises (1) a first appliance for priming a tooth to cause the tooth to be in a primed state, and (2) the second appliance and successive appliances for moving the tooth from the primed state to a predetermined final position. The second appliance can have a geometry selected to reposition the teeth from the primed state to a first intermediate arrangement;

(b) optionally one or more intermediate appliances having geometries selected to progressively reposition the teeth from the first intermediate arrangement to successive intermediate arrangements; and

(c) a final appliance having a geometry selected to progressively reposition the teeth from the last intermediate arrangement to the final tooth arrangement.

The successive locks can be formed of a material that includes a metallic material, a plastic material, and/or a polymeric material. Some examples of the locks include, e.g., metal wires or clips, hard plastic clips, ceramic clips, or elastic polymeric shells or rings. In some embodiments, the term “lock” can be used interchangeably with the term “geometry.” In some embodiments, the locks specifically exclude polymeric shells.

In some embodiments, the appliances can be made to have different configurations to achieve different force systems. For example, the shells or rings on an appliance can have at least a region including two or more layers of a polymeric material to achieve the force system. In some embodiments, the shells or locks can be made to have uniform or non-uniform stiffness, elastic modulus, and/or thickness in part or the entire body of the shell or lock to generate the force system.

The system provided herein can be specified in the ways known in the art. For example, in a cycle, each appliance can carry specifications for the differential force, for example, specifying the dimensions of one or more appliances, such as the thickness or diameter of the appliances or the material characteristics forming the appliances, such as high, medium, or low differential force. These specifications of the appliances can be marked on each appliance or alternatively, marked on tags or by placement in a package. Some or all of the appliances in a cycle can further bear numeric marks, for example, numbers from 0 through 25 to indicate the anticipated discrepancy between actual teeth positions and expected (predicted) teeth positions as a result of successive changes in appliance geometry.

In some embodiments, to increase anchorage of the appliance, a dental implant can be used in association with the cycle of appliances. The implant can be palatally placed or buccally placed or placed on the retromolar area.

Materials for Realignment Appliances

The realigning appliances can be formed of an elastic material that can include one or more polymers. The polymer is preferably inert and biocompatible. The polymer is also sufficiently flexible to allow easy removal and application for the user, but also sufficiently rigid to allow controlled teeth movement. Any conventional material normally used in dental treatments for fabricating removable appliances can be used in this invention. Specific examples of useful polymers include any elastic polymeric materials, such as those commonly used in the art of dentistry, e.g, olefin polymers or copolymers, such as polyethlyene, polybutylene, polyisobutylene, polypropylene, ethylene vinyl acetate, polyvinyl alcohol, polystyrene, copolymers that include two or more of ethylene, propylene, butylene, isobutene, pentene, styene, vinyl acetate, vinyl alcohol and a combination thereof, or a mixture thereof. The polymeric material can further include a material to modify the biocompatibility. Such biocompatibility modifying materials include, e.g., polyethylene glycol, polypropylene glycol, polyethylene oxide or a natural polymer such as cellulose or alginate, collagen, and the like.

In some embodiment, the polymeric materials can further include a reinforcing material such as fibers, chips, wires, glass fibers, carbon fibers, pieces, strips, mesh, lattices, and networks and interpenetrating networks. Some representative reinforcing materials include, for example, micro or nano aluminum oxide phases, carbon fibers, etc, or mixtures thereof.

Method of Forming the Realignment Appliances

The system can be formed by (a) receiving prescribed orthodontic information for a user in need of orthodontic treatment, (b) forming a cycle of appliances comprising individual appliances, and (c) forming a cycle of appliances. In some embodiments, the appliances for realigning tooth can be formed based on the position of the primed state of the tooth and the predetermined final position. The primed state of the tooth can be predicted in reference to the initial position of the tooth. Such methods of forming tooth moving appliances are well documented in the art, such as the methods/processes described in U.S. Pat. Nos. 6,398,548; 6,544,611; 5,895,893; 6,244,861; 6,616,444; 5,645,420; and 5,447,432, the teachings of which are incorporated herein by reference.

In one aspect, the appliances can be formed by (1) generating/obtaining an initial data set such as an initial digital data set (IDDS) representing the primed state of a tooth, (2) generating a digital data set (DDS) or non-digital data set (NDDS) representing an intermediate tooth arrangement, (3) generating an end or a final data set such as a DDS or NDDS representing an end tooth arrangement or a final tooth arrangement, and (4) optionally producing a plurality of successive digital data sets based on both of the first digital data set and the final digital data set, wherein the plurality of successive data sets represent a series of successive tooth arrangements progressing from the intermediate tooth arrangement last end tooth arrangement to the end tooth arrangement or the final tooth arrangement, and (5) forming an appliance or a plurality of appliances based on the digital data sets. In some embodiments, the digital data sets can be converted into visual images representing a tooth arrangement, and the appliances can be formed based on the visual images. Methods of obtaining the IDDS and DDS, generating a visual image based on DDS and forming an appliance based on the visual image are described in U.S. Pat. Nos. 6,398,548; 6,544,611; 5,895,893; 6,244,861; 6,616,444; 5,645,420; and 5,447,432, the teachings of which are incorporated herein by reference.

The initial digital data set can be provided by any techniques known in the art, including digitizing X-ray images, images produced by computer-aided tomography (CAT scans), images produced by magnetic resonance imaging (MRI), images produced by photo scanning, and the like. The images will be three-dimensional images and digitization can be accomplished using known technology. For example, the initial digital data set is provided by producing a plaster cast of the user's teeth (prior to treatment) by techniques known in the art. The plaster cast so produced can then be scanned using laser or other scanning equipment to produce a high resolution digital representation of the plaster cast of the user's teeth.

In a preferred embodiment, a wax bite is also obtained from the user using standard methods. The wax bite allows plaster casts of a user's upper and lower dentition to be placed relative to one another in the centric occlusal position. The pair of casts then can be scanned to provide information on the relative position of the jaw in this position. This information is then incorporated into the IDDS for both arches.

Once the digital data set is acquired, an image can be presented and manipulated on a suitable computer system equipped with computer-aided design software, as described in greater detail below. The image manipulation will usually comprise defining boundaries about at least some of the individual teeth, and causing the images of the teeth to be moved relative to the jaw and other teeth by manipulation of the image via the computer. Methods are also provided for detecting cusp information for the teeth. The image manipulation can be done entirely subjectively, i.e. the user can simply reposition teeth in an aesthetically and/or therapeutically desired manner based on observation of the image alone. Alternatively, the computer system could be provided with rules and algorithms which assist the user in repositioning the teeth. In some instances, it will be possible to provide rules and algorithms which reposition the teeth in a fully automatic manner, i.e. without user intervention. Once the individual teeth have been repositioned, a final digital data set representing the desired final tooth arrangement will be generated and stored.

An exemplary method for determining the final tooth arrangement is for the treating professional to define the final tooth positions, e.g. by writing a prescription. The use of prescriptions for defining the desired outcomes of orthodontic procedures is well known in the art. When a prescription or other final designation is provided, the image can then be manipulated to match the prescription. In some cases, it would be possible to provide software which could interpret the prescription in order to generate the final image and thus the digital data set representing the final tooth arrangement.

In yet another aspect, methods described herein are provided for producing a plurality of digital data sets representing a series of discrete tooth arrangements progressing from an initial tooth arrangement to a final tooth arrangement. Such methods comprise providing a digital data set representing an initial tooth arrangement (which can be accomplished according to any of the techniques set forth above). A digital data set representing a final tooth arrangement is also provided. Such final digital data set can be determined by the methods described previously. A plurality of successive digital or non-digital data sets are then produced based on the initial digital data set and the final digital data set. Usually, the successive digital data sets are produced by determining positional differences between selected individual teeth in the initial data set and in the final data set and interpolating said differences. Such interpolation can be performed over as many discrete stages as can be desired, usually at least three, often at least four, more often at least ten, sometimes at least twenty-five, and occasionally forty or more. Many times, the interpolation will be linear interpolation for some or all of the positional differences. Alternatively, the interpolation can be non-linear. In a preferred embodiment, non-linear interpolation is computed automatically by the computer using path scheduling and collision detection techniques to avoid interferences between individual teeth. The positional differences will correspond to tooth movements where the maximum linear movement of any point on a tooth is 2 mm or less, usually being 1 mm or less, and often being 0.5 mm or less.

Often, the user will specify certain target intermediate tooth arrangements, referred to as “key frames,” which are incorporated directly into the intermediate digital data sets. The methods of the present invention then determine successive digital data sets between the key frames in the manner described above, e.g. by linear or non-linear interpolation between the key frames. The key frames can be determined by a user, e.g. the individual manipulating a visual image at the computer used for generating the digital data sets, or alternatively can be provided by the treating professional as a prescription in the same manner as the prescription for the final tooth arrangement.

In still another aspect, methods described herein provide for fabricating a plurality of dental incremental position adjustment appliances. Said methods comprise providing an initial digital data set, a final digital or non-digital data set, and producing a plurality of successive digital or non-digital data sets representing the target successive tooth arrangements, generally as just described. The dental appliances are then fabricated based on at least some of the digital data sets representing the successive tooth arrangements. Preferably, the fabricating step comprises controlling a fabrication machine based on the successive digital data sets to produce successive positive models of the desired tooth arrangements. The dental appliances are then produced as negatives of the positive models using conventional positive pressure or vacuum fabrication techniques. The fabrication machine can comprise a stereolithography or other similar machine which relies on selectively hardening a volume of non-hardened polymeric resin by scanning a laser to selectively harden the resin in a shape based on the digital data set. Other fabrication machines which could be utilized in the methods of the present invention include tooling machines and wax deposition machines.

In still another aspect, methods of the present invention for fabricating a dental appliance comprise providing a digital data set representing a modified tooth arrangement for a user. A fabrication machine is then used to produce a positive model of the modified tooth arrangement based on the digital data set. The dental appliance is then produced as a negative of the positive model. The fabrication machine can be a stereolithography or other machine as described above, and the positive model is produced by conventional pressure or vacuum molding techniques.

In a still further aspect, methods for fabricating a dental appliance described herein comprise providing a first digital data set representing a modified tooth arrangement for a user. A second digital data set is then produced from the first digital data set, where the second data set represents a negative model of the modified tooth arrangement. The fabrication machine is then controlled based on the second digital data set to produce the dental appliance. The fabrication machine will usually rely on selectively hardening a non-hardened resin to produce the appliance. The appliance typically comprises a polymeric shell having a cavity shape to receive and resiliently reposition teeth from an initial tooth arrangement to the modified tooth arrangement.

In some embodiments, the orthodontic doctor can take an imprint or scan a last intermediate tooth arrangement after the user has undergone the treatment of one or more cycles of appliances. A digital data set of the last intermediate tooth arrangement of the previous cycle thus can be obtained based on the imprint or scan. This digital data set of the last intermediate tooth arrangement of the previous cycle is then used as the initial point for generating a new set of digital data and visual images based on the new set of digital data representing one or more new intermediate tooth arrangements and a final tooth arrangement for the fabrication of a new cycle of appliances.

In some embodiments, the final tooth arrangement can be achieved with the application of two or more cycles of appliances, and each cycle of the appliances incrementally move the teeth starting from the tooth arrangement positioned by the last appliance of the previous cycle. Cycles of appliances can therefore be made according to the principles described above.

Method of Using

According to a method of the present invention, a user's teeth are repositioned from an initial tooth arrangement to a final tooth arrangement by placing a series of priming and incremental position adjustment appliances in the user's mouth. Conveniently, the appliances are not affixed and the user can place and replace the appliances at any time during the procedure. The first appliance of the series will provide transduction cyclic mechanical force for priming teeth to cause the teeth to assume the primed state and a second appliance will have a geometry selected to reposition the teeth from the primed state to a first intermediate arrangement. The priming of teeth/tooth can take a period of minutes to hours or days, for example, about 2 hours, about 6 hours, about 10 hours, about 24 hours, about 48 hours, about 72 hours.

After the first intermediate arrangement is approached or achieved, one or more additional (intermediates appliances will be successively placed on the teeth, where such additional appliances have geometries selected to progressively reposition teeth from the first intermediate arrangement through successive intermediate arrangement(s). The treatment will be finished by placing a final appliance in the user's mouth, where the final appliance has a geometry selected to progressively reposition teeth from the last intermediate arrangement to the final tooth arrangement. The final appliance or several appliances in the series can have a geometry or geometries selected to over correct the tooth arrangement, i.e. have a geometry which would (if fully achieved) move individual teeth beyond the tooth arrangement which has been selected as the “final.” Such over correction can be desirable in order to offset potential relapse after the repositioning method has been terminated, i.e. to permit some movement of individual teeth back toward their pre-corrected positions. Over correction can also be beneficial to speed the rate of correction, i.e. by having an appliance with a geometry that is positioned beyond a desired intermediate or final position, the individual teeth will be shifted toward the position at a greater rate. In such cases, treatment can be terminated before the teeth reach the positions defined by the final appliance or appliances. The method will usually comprise placing at least two additional appliances, often comprising placing at least ten additional appliances, sometimes placing at least twenty-five additional appliances, and occasionally placing at least forty or more additional appliances. Successive appliances will be replaced when the teeth either approach (within a preselected tolerance) or have reached the target end arrangement for that stage of treatment, typically being replaced at an interval in the range from 2 days to 20 days, usually at an interval in the range from 5 days to 10 days.

Often, it can be desirable to replace the appliances at a time before the “end” tooth arrangement of that treatment stage is actually achieved. It will be appreciated that as the teeth are gradually repositioned and approach the geometry defined by a particular appliance, the repositioning force on the individual teeth will diminish greatly. Thus, it can be possible to reduce the overall treatment time by replacing an earlier appliance with the successive appliance at a time when the teeth have been only partially repositioned by the earlier appliance. Thus, the FDDS can actually represent an over correction of the final tooth position. This both speeds the treatment and can offset user relapse.

In general, the transition to the next appliance can be based on a number of factors. Most simply, the appliances can be replaced on a predetermined schedule or at a fixed time interval (i.e. number of days for each appliance) determined at the outset based on an expected or typical user response. Alternatively, actual user response can be taken into account, e.g. a user can advance to the next appliance when that user no longer perceives pressure on their teeth from a current appliance, i.e. the appliance they have been wearing fits easily over the user's teeth and the user experiences little or no pressure or discomfort on his or her teeth. In some cases, for users whose teeth are responding very quickly, it can be possible for a treating professional to decide to skip one or more intermediate appliances, i.e. reduce the total number of appliances being used below the number determined at the outset. In this way, the overall treatment time for a particular user can be reduced.

In another aspect, methods of the present invention comprise repositioning teeth using appliances comprising polymeric shells having cavities shaped to receive and resiliently reposition teeth to produce a final tooth arrangement. The present invention provides improvements to such methods which comprise determining at the outset of treatment geometries for at least three of the appliances which are to be worn successively by a user to reposition teeth from an initial tooth arrangement to the final tooth arrangement. Preferably, at least four geometries will be determined in the outset, often at least ten geometries, Frequently at least twenty-five geometries, and sometimes forty or more geometries. Usually, the tooth positions defined by the cavities in each successive geometry differ from those defined by the prior geometry by no more than 2 mm, preferably no more than 1 mm, and often no more than 0.5 mm, as defined above.

The system can be used to treat or prevent orthodontic conditions such as malalignment, crowding, spacing, overjet, overbite problem, and a combination thereof.

While the above is a complete description of the preferred embodiments of the invention, various alternatives, modifications, and equivalents can be used. Therefore, the above description should not be taken as limiting the scope of the invention which is defined by the appended claims.

1. A system for repositioning teeth from an initial tooth arrangement to a final tooth arrangement, said system comprising a plurality of dental incremental position adjustment appliances including:
a first appliance for priming teeth in an initial tooth arrangement to assume a primed state;
a second appliance having a geometry selected to reposition the teeth from the primed state to a first intermediate arrangement;
one or more intermediate appliances having geometries selected to progressively reposition the teeth from the first intermediate arrangement to successive intermediate arrangements; and
a final appliance having a geometry selected to progressively reposition the teeth from the last intermediate arrangement to the final tooth arrangement,
wherein the primed state is characterized by enhanced osteoblast activities in the tissue surrounding the teeth and loosened rooting of the teeth.

2. The system of claim 1, wherein the appliances comprise polymeric shells having cavities shaped to receive and resiliently reposition teeth from one arrangement to a successive arrangement.

3. The system of claim 2, wherein the tooth positions defined by the cavities in each successive appliance differ from those defined by the prior appliance by no more than 2 mm.

4. The system of claim 1, comprising at least two intermediate appliances, at least ten intermediate appliances or at least twenty-five intermediate appliances.

5. (canceled)

6. (canceled)

7. The system of claim 1, wherein the appliances are marked with sequential numbering directly on the appliances, marked on tags which are affixed to the appliances, or marked by placement in a pouch.

8. (canceled)

9. (canceled)

10. The system of claim 1, further comprising instructions which set forth that the patient is to wear the individual appliances in the order marked on the appliance.

11. The system of claim 1, wherein the first appliance comprises a transducer material capable of generating a cyclic force upon exposure to a stimulus.

12. The system of claim 11, wherein the first appliance comprises a transducer shell.

13. The system of claim 11, wherein the cyclic force has a magnitude above about 0.001 Newton or has a frequency above about 0.001 Hz.

14. (canceled)

15. The system of claim 13, wherein the transducer material is selected from the group consisting of piezoelectric crystals, piezoelectric ceramics, piezoelectric polymers, magneostrictive alloys, electrostrictive ceramics, and combinations thereof.

16. The system of claim 11, wherein the stimulus is a magnetic field or electric current, and
wherein electric current is generated by a battery cell in the device.

17. (canceled)

18. The system of claim 11, wherein the first appliance is effective for multiple teeth stimulation or is effective for single tooth stimulation.

19. (canceled)

20. A method for repositioning teeth from an initial tooth arrangement to a final tooth arrangement, said method comprising:
placing a first appliance in a patient's mouth for priming the teeth to cause the teeth to assume a primed state;
placing a second appliance in a patient's mouth, wherein the second appliance has a geometry selected to reposition the teeth from the initial tooth arrangement to a first intermediate arrangement;
successively replacing one or more optional additional appliances, wherein the additional appliances have geometries selected to progressively reposition the teeth from the first intermediate arrangement to successive intermediate arrangements; and
placing an optional final appliance into the patient's mouth, wherein the final appliance has a geometry selected to progressively reposition the teeth from the last intermediate arrangement to the final tooth arrangement, and
wherein the use of the optional additional appliances or the optional final appliance depends on conditions (1) and (2):
(1) the optional final appliance is used if the last intermediate arrangement is not the final tooth arrangement; and
(2) the optional additional appliances is used if the first intermediate arrangement is not the final tooth arrangement.

21. The method of claim 20, wherein the second appliance, the optional additional appliances, and the optional final appliance comprise polymeric shells having cavities shaped to receive and resiliently reposition teeth from one arrangement to a successive arrangement.

22. The method of claim 21, where the tooth positions defined by the cavities in each successive appliance differ from those defined by the prior appliance by no more than 2 mm.

23. The method of claim 20, wherein the successively placing step comprises placing at least two additional appliances prior to placing the final appliance, at least ten additional appliances prior to placing the final appliance, or at least twenty-five additional appliances prior to placing the final appliance.

24. (canceled)

25. (canceled)

26. The method of claim 20, wherein the appliances are successively replaced at an interval in the range from about 2 days to about 20 days.

27. (canceled)

28. The method of claim 20, wherein the first appliance comprises a transducer material capable of generating a cyclic force upon exposure to a stimulus.

29. The method of claim 28, wherein the first appliance comprises a transducer shell.

30. The method of claim 28, wherein the cyclic force has a magnitude above about 0.001 Newton or has a frequency above about 0.001 Hz.

31. (canceled)

32. The method of claim 28, wherein the transducer material is selected from the group consisting of piezoelectric crystals, piezoelectric ceramics, piezoelectric polymers, magneostrictive alloys, electrostrictive ceramics, and combinations thereof.

33. The method of claim 28, wherein the stimulus is a magnetic field or electric current, and
wherein electric current is generated by a battery cell in the device.

34. (canceled)

35. The method of claim 28, wherein the first appliance is effective for single tooth stimulation or effective for multiple teeth stimulation.

36. (canceled)
